(19) United States
(12) Patent Application Publication
(10) Pub. No.: US 2009/0041136 A1
(43) Pub. Date: Feb. 12, 2009

(54) METHOD AND APPARATUS FOR RECOGNITION OF TRANSMISSION PARAMETER SIGNALING (TPS) AT FREQUENCY DOMAIN IN A TDS-OFDM RECEIVER

(75) Inventor: HAIYUN YANG, SAN JOSE, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/835,621

(22) Filed: Aug. 8, 2007

(51) Int. Cl. H04J 11/00

(52) U.S. Cl. 375/260

(57) ABSTRACT

A receiver comprises a method is provided. The method has the step of: determining a transmission parameter signaling (TPS) parameter based a group of vectors inherent to a communication system.

### CROSS-REFERENCE TO OTHER APPLICATIONS

The following applications of common assignee are related to the present application, and are herein incorporated by reference in their entireties:

“Receiver Structure for an LDPC-Based TDS-OFDM Communication System” Ser. No. 11/740,712, filed Apr. 26, 2007, Attorney Docket No. LSC-P016.

“METHOD AND DEVICE FOR HIGH THROUGHPUT N-POINT FORWARD AND INVERSE FAST FOURIER TRANSFORM” Ser. No. 11/550,390, filed Oct. 17, 2006, Attorney Docket No. LSFFT-025.

### FIELD OF THE INVENTION

The present invention relates generally to OFDM transceivers, more specifically the present invention relates to Recognition of Transmission Parameter Signaling (TPS) at Frequency Domain in a time-domain synchronous OFDM (TDS-OFDM) Receiver.

### BACKGROUND

For a digital transmission system, such as the Chinese DTV terrestrial transmission standard, for each signal frame here is a transmission parameter signaling (TPS). An efficient means for obtaining the TPS is desired and provided.

### SUMMARY OF THE INVENTION

A method and system for extracting a TPS vector based on an inherent characteristic of a communications system is provided.

A method and system for extracting a TPS vector based on an inherent characteristic of a TDS-OFDM system is provided.

A method and system for extracting a TPS vector based on a group of vectors inherent to a communications system with each vector having a functional relationship with another vector within the group is provided.

A method and system for extracting a TPS vector based on a group of vectors inherent to a TDS-OFDM system with each vector having a functional relationship with another vector within the group is provided.

A device comprises a method is provided. The method has the step of: determining a transmission parameter signaling (TPS) parameter based a group of vectors inherent to a communication system.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of an OFDM frame in accordance with some embodiments of the invention.

FIG. 2 is an example of a transmitter in accordance with some embodiments of the invention.

FIG. 3 is an example of a receiver in accordance with some embodiments of the invention.

FIG. 4 is an example of a first scheme in accordance with some embodiments of the invention.

FIG. 5 is an example of a second scheme in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to extracting a TPS vector based on a group of vectors inherent to a TDS-OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of extracting a TPS vector based on a group of vectors inherent to a TDS-OFDM system described herein. The non-processor circuits may include, but are not limited to, a radio receiver, a radio transmitter, signal drivers, clock circuits, power source circuits, and user input devices. As such, these functions may be interpreted as steps of a method to perform extracting a TPS vector based on a group of vectors inherent to a TDS-OFDM system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

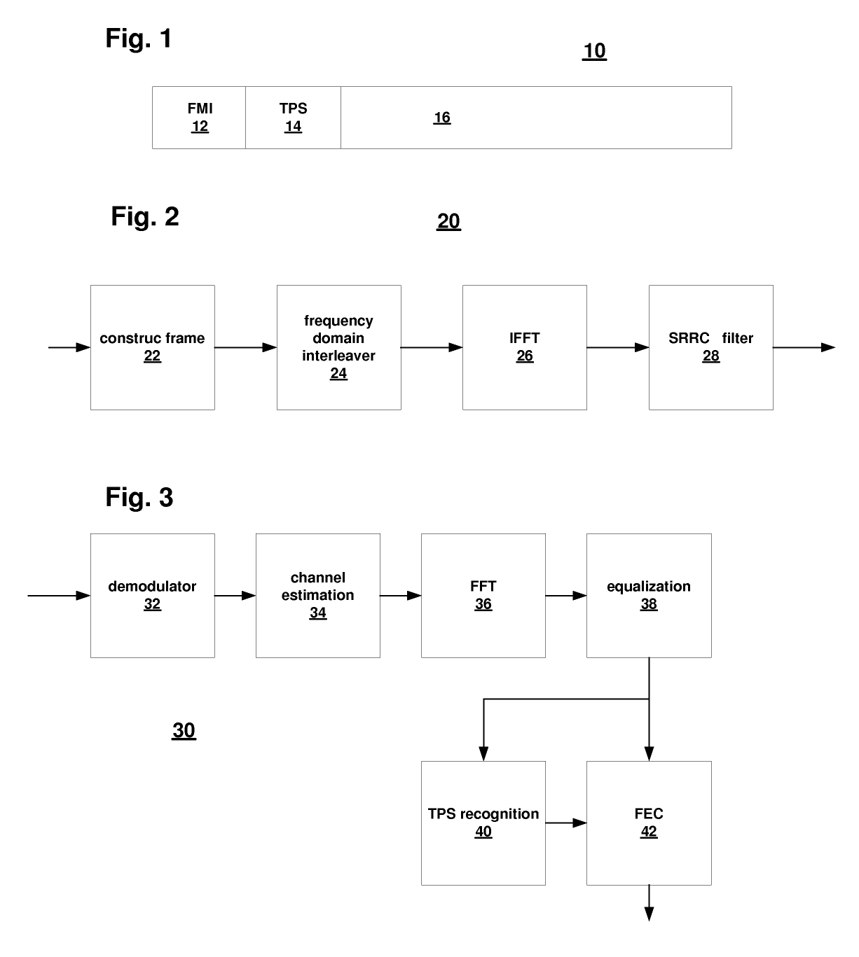

Referring to FIGS. 1-5, in wireless digital transmission system, such as the Chinese DTV terrestrial transmission standard, for each signal frame 10 there is a transmission parameter signaling (TPS) vector 14. The TPS vector 14 has 32 bits. As shown in Table 1, each vector is used to indicate a specific combination of modulation mode, FEC rate, and time-interleaver mode. Frame 10 further comprises a 4 bit frame mode indications (FMI) 12. Table 1 is an exemplified TPS Vector Table.

TABLE I
TPS Vector Table

| Index | | |
|---|---|---|
| Nos. | TPS vector | Information |
| 1 | 00011110101011100100100010110011 | frame 0 of odd super |
| | | frames |
| 2 | 11100001010100011011011101001100 | frame 0 of even super |
| | | frames |
| 3 | 01111000110010000010111011010101 | 4QAM-NR, rate 3, tm 1 |
| 4 | 10000111001101111101000100101010 | 4QAM-NR, rate 3, tm 2 |
| 5 | 01110111110001110010000111011010 | 4QAM, rate 1, tm 1 |
| 6 | 10001000001110001101111000100101 | 4QAM, rate 1, tm 2 |
| 7 | 00100010100100100111010010001111 | 4QAM, rate 2, tm 1 |
| 8 | 11011101011011011000101101110000 | 4QAM, rate 2, tm 2 |
| 9 | 01001011111110110001110111100110 | 4QAM, rate 3, tm 1 |
| 10 | 10110100000001001110001000011001 | 4QAM, rate 3, tm 2 |
| 11 | 00010001101000010100011110111100 | 16QAM, rate 1 tm 1 |
| 12 | 11101110010111101011100001000011 | 16QAM, rate 1, tm 2 |
| 13 | 01111000001101110010111000101010 | 16QAM, rate 2, tm 1 |
| 14 | 10000111110010001101000111010101 | 16QAM, rate 2, tm 2 |
| 15 | 00101101100111010111101110000000 | 16QAM, rate 3, tm 1 |
| 16 | 11010010011000101000010001111111 | 16QAM, rate 3, tm 2 |
| 17 | 01110111001110000010000100100101 | 32QAM, rate 2, tm 1 |
| 18 | 10001000110001111101111011011010 | 32QAM, rate 2, tm 2 |
| 19 | 00100010011011010111010001110000 | 64QAM, rate 1, tm 1 |
| 20 | 11011101100100101000101110001111 | 64QAM, rate 1, tm 2 |
| 21 | 01000100000010110001001000010110 | 64QAM, rate 2, tm 1 |
| 22 | 10111011111101001110110111101001 | 64QAM, rate 2, tm 2 |
| 23 | 00010001010111100100011101000011 | 64QAM, rate 3, tm 1 |
| 24 | 11101110101000011011100010111100 | 64QAM, rate 3, tm 2 |

As can be seen according to Table I, there are five modulation modes, three FEC rates, and two time interleaver modes. The five modulation modes are respectively 4QNR, 4QAM, 16QAM, 32QAM and 64QAM. The three FEC rates are rate 1, rate 2 and rate 3. The two time interleaver modes are tm 1 and tm 2.

The five modulation modes are respectively 4QNR, 4QAM, 16QAM, 32QAM and 64QAM. The three FEC rates are rate 1, rate 2 and rate 3. The two time interleaver modes (tm 1 and tm 2). The first 2 vectors are for frame 0 indication. The remaining 22 vectors are used to indicate one possible combination of modulation mode, FEC rate and time-interleaver mode.

These 32-bit TPS vectors in combination with the 4-bit FMI vectors (frame mode indications) generate a set of 36-bit vectors. This vector within the set is always modulated using 4QAM which both equal I and Q. The modulated signal is combined with the 3744 data symbols 16. These 3744 symbols 16 are modulated in the way indicated by the TPS vector of the current frame in a predetermined manner.

For transmission, the 36 symbols from FMI 12 and TPS vector 14 and 3744 data symbols 16 constitute one signal frame 10 as shown in FIG. 1.

FIG. 2 is a simplified block diagram of the transmitter 20. Information first goes through frame construction 22. The constructed frame goes through frequency domain interleaving 24. The signal frame 10 with 3780 symbols is first interlaced 22 by the frequency domain interleaver 24, and then converted into time domain using IFFT block 26. The inversely transformed signal is further subject to a SRRC filter 28. For simplity, some blocks in the TDS-OFDM transmitter, such as PN generation is omitted.

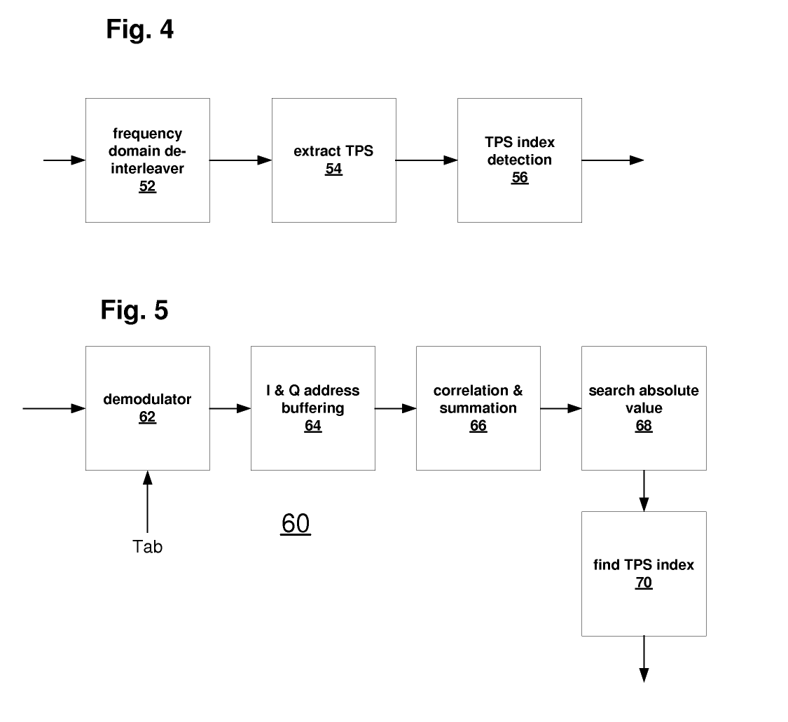

In FIGS. 2-5, receiver side depictions are shown. TPS need to be recognized in a receiver. FIG. 3 presents a simplified diagram 30 of a TDS-OFDM receiver. The received signals are first demodulated 32. The demodulated signals are further subjected to channel estimation 34. The estimated signal further goes through a transformation into the frequency domain 36. The transformed information is further equalized 38. The equalized information first is subjected to TPS recognition 40 the rest of the information goes through for forward error correction 42. Since TPS vector 14 carries the information about the modulation, FEC rate, and time-interleaver, the TPS vector 14 has to be received and recognized first before the data symbol 16 can be correctly received within the received signal that is finally decoded by the FEC decoder 42. Since at the transmitter side, there is a frequency-domain interleaver 24, conceptually, at the receiver side, the signal after the “Equalization” 38 should be the de-interleaver 52 as shown in FIG. 4. After the frequency-domain de-interleaving 52, the symbol 16 at position 4, 5, . . . , 35 are extracted 54, and then this received TPS vector 14 is processed to obtain the TPS index by the block “TPS index Detection” 56. Note that FIG. 4 shows a typical TPS index detection without taking advantage of the characteristics of a TDS-OFDM system.

However, to take advantage of the characteristics of the TDS-OFDM system, when the actual implementation of FFT generates the output in a mixed order (see U.S. patent application Ser. No. 11/550,390, filed Oct. 17, 2006, Attorney Docket No. LSFFT-025), this frequency-domain de-interleaver block 52 (see FIG. 4) can be by-passed as long as the symbol at position given by Table 1 is pick up sequentially.

FIG. 5 presents a detailed block diagram 60 for TPS recognition 40 of FIG. 3. As mentioned above, since the output of the FFT block 36 is in the mixed order rather than the natural order (see U.S. patent application Ser. No. 11/550,390, filed Oct. 17, 2006, Attorney Docket No. LSFFT-025), the “Extract TPS symbol” block 54 needs to extract the TPS symbols 14 at the position of 0, 140, 279, . . . . (see Table 2).

{0, 140, 279, 419, 420, 560, 699, 839, 840, 980, 1119, 1259, 1260, 1400, 1539, 1679, 1680, 1820, 1859, 2099, 2100, 2240, 2379, 2519, 2520, 2660, 2799, 2939, 2940, 3080, 3219, 3359, 3360, 3500, 3639, 3779}

Table 2

Position 0 is the 1^{st} symbol of 3780 symbols in one frame. Position 1 is the 2^{nd} symbol of 3780 symbols in the same frame. After the extraction or demodulation 62, a 32-symbol complex vector is generated. “I&Q addition buffer” block 64 adds both the I component and the Q component of each 32 TPS symbols and a 32-symbol scalar vector, noted as {s(i):i=0,1, . . . ,31}.

In the “correlation & Summation” block 66, the input v vector {s(i):i=0,1, . . . ,31} is correlated with the vectors with index 1, 3, 5, . . . 23 (odd numbered lines) in the TPS vector table 1. Since the element in the TPS vectors is either 0 or 1, the correlation is actually addition or subtraction. Let's say one TPS vector is expressed as {v(i):i=0,1, . . . ,31}. The correlation operation is:

$$c ( k ) = {\sum }_{i = 0}^{31} sign ( c ( i ) ) s ( i )$$

$$where$$

$$k = 1 , 3 , 5 , … , 23$$

$$and$$

$$sign ( x ) = \{ \begin{matrix}+ 1 & x = 0 \\ - 1 & x = 1\end{matrix}$$

In the “search max of absolute value” block 68, the max value of absolute value of c(k) and the sign of the corresponding c(k) is found after searching the 12 candidates. The final index of TPS vector of is obtained 70.
If sign=1, idx_tps=index_abs*2
If sign=0, idx_tps=index_abs*2+1

With the determined idx_tps, the modulation mode, FEC rate and time interleaver mode are obtained using Table 1. Note a characteristic of Table is that it includes a pair of values where one element of the pair is the opposite of the other. For example, pair 1 includes lines 1 and 2. The zeros in line 1 respectively correspond to Is in line 2. As can be seen, the elements of line 2 is the complement of line 1. More generally, a functional relationship exists between line 1 and line 2. Still more generally, a functional relationship exists between a group of lines, or more than 2 lines.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method comprising the step of:
determining a transmission parameter signaling (TPS) parameter based a group of vectors inherent to a communication system.

2. The method of claim 1, wherein the communication system is a TDS-OFDM communication system.

3. The method of claim 1, wherein the group of vectors comprises a pair of vectors.

4. The method of claim 3, wherein a first vector of the pair of vectors includes positioned elements having a distinct complementary element positioned in a second vector of the pair of vectors.

5. A receiver comprising a method having the step of:
determining a transmission parameter signaling (TPS) parameter based a group of vectors inherent to a communication system.

6. The method of claim 5, wherein the communication system is a TDS-OFDM communication system.

7. The method of claim 6, wherein the group of vectors comprises a pair of vectors.

8. The method of claim 7, wherein a first vector of the pair of vectors includes positioned elements having a distinct complementary element positioned in a second vector of the pair of vectors.
